(19) United States
(12) Patent Application Publication
(10) Pub. No.: US 2002/0002534 A1
(43) Pub. Date: Jan. 3, 2002

(54) Method and system for managing transactions

(76) Inventors: Terry L. Davis, Scottsdale, AZ (US); John W. Sears, Glendale, AZ (US); Yvan Y. Baudoin, Phoenix, AZ (US)

Correspondence Address: R. Lee Fraley, Snell & Wilmer L.L.P., One Arizona Center, 400 E. Van Buren, Phoenix, AZ, 85004-2202, US

(21) Appl. No.: 09/894,252

(22) Filed: Jun. 27, 2001

Related U.S. Application Data
(60) Provisional application No. 60/214,537, filed on Jun. 27, 2000.

(51) Int. Cl. G06F 17/60

(52) U.S. Cl. 705/39; 705/35; 235/379

(57) ABSTRACT

A high speed, highly secure transaction management system and method capable of managing large volumes of complex transactions, that require a high level of security, from a plurality of transaction sources is provided. Such transaction sources may include, but are not limited to, the electronic toll and fare collection industry. The transaction management system may include tamper resistant hardware containing, for example, memory and data storage components, and a processor device for controlling, processing and managing transactions and related data and information, and may be configured with one or more processing components. In addition, the transaction management system can be suitably configured for facilitating offline payment transactions, for example a payment transaction that can be conducted locally, rather than through a post processing of a prepaid account, or through use of an intelligent, agency specific transponder device. For example, a transaction management system can be suitably configured for facilitating payment of transactions by storing value on a smart card component or module interfaces to a transponder device, and for debiting and crediting the stored value as transactions are incurred locally with the smart card device. The smart card component can be configured to authorize payment and collect transaction records in such a manner as to allow settlement of funds between various issuers, acquirers and operators of electronic toll collection systems. As a result, the process can significantly increase the speed of transactions, thus enabling the transactions to occur locally, such as when a transponder is proximate to a toll collection system. Further, the transaction management system can be configured to address multiple types of applications. For example, an exemplary transaction management system can address high volume transactions, multiple processing transactions, different types of transactions, and different types of collection systems.

### CROSS-REFERENCE TO RELATED APPLICATIONS

This application claims priority from prior pending U.S. Provisional Application Ser. No. 60/214,537, entitled “Method and System for Managing Transactions,” filed Jun. 27, 2000.

### FIELD OF INVENTION

The present invention relates generally to automated systems for performing secure electronic transactions at very high speeds. In particular, the present invention relates to a method and system for managing transactions, including the secure executing, processing, and logging of complex, high speed electronic transactions, such as payment transactions configured with automated payment collection equipment and devices.

### BACKGROUND OF THE INVENTION

The continued migration from manual payment systems to electronic payment systems has resulted in the conventional payment systems being replaced with high speed, automated transaction processing systems to minimize and/or reduce transaction, collection and processing costs through improved efficiencies. For example, existing cash-based systems utilize labor-intensive methods for collecting and processing payments, thus relying on error prone cash accounting procedures and printed reports to audit, reconcile and settle the payment accounts. In the newer, high speed transaction systems, electronic transactions are generated utilizing smart devices in connection with complex, automated methods for collecting and processing electronic transactions. However, the greater the increase in automation in the transaction process, the greater the increase in demand for secure high speed transaction processing systems. As a result of the increase in the use of such electronic payment devices, many companies have difficulty in processing the increased number of complex transactions, particularly those systems that are required to process many simultaneous transactions within a fixed time frame.

One payment and collection application, among others, that has experienced difficulty in the collecting and processing of electronic transactions includes tolling transaction applications, such as those provided at the toll collection facilities on many interstate and intrastate highway systems. With reference to FIG. 1, an exemplary toll transaction system 100 is illustrated.

Typically, toll transaction system 100 includes a vehicle tag device 102 comprising a smart device configured for communicating to one or more toll usage collection systems 103 that are connected to a processing and account management system 112. Toll transaction system 100 is generally designed for detecting the presence of a vehicle, i.e., detecting vehicle tag device 102, within a designated area of toll usage collection systems 103, validating the status of vehicle tag device 102, and for processing the transaction in processing and account management system 112. Present automated toll collection systems generally utilize one of two methods for handling transactions, including a preloaded account method for payment and a stored value method for payment.

For communicating to vehicle tag device 102, such as a vehicle mounted tag or transponder device, toll collection systems 103 are generally configured with receiving antennae 104 or other wireless communication methodologies. These antennae 104 can enable tag reader devices 106 to communicate with vehicle tag devices 102 when the vehicles approach within a designated distance from toll collection systems 103, e.g., within a predetermined distance from a toll plaza. Toll collection systems 103 can also have lane controlling and sensing equipment 108 that can measure or assess certain vehicle characteristics, as well as a host system 110 for controlling the operation of the various devices, modules and components and for logging or otherwise processing usage transactions.

In the preloaded account method, each tag device 102 within a vehicle is typically is required to be pre-loaded with information corresponding to the issuing agency, e.g., information for identifying the particular agency that issued tag device 102 and any other agency specific criteria, and information corresponding to the vehicle, such as the type of vehicle that has been issued tag device 102, e.g., whether commercial or non-commercial, as well as whether a car, truck, bus or other mode of transportation. Prior to initial use, one or more tag devices 102 are usually associated with a prepaid toll account obtained by the user when tag devices 102 are issued by the agency, and which is maintained at processing and account management system 112. In addition, tag device 102 is also designed to furnish information about the vehicle class to the lane controlling equipment 108. This information is used to verify that tag device 102 belongs with a particular class of vehicle, and for controlling the lane equipment 108, such as a vehicle enforcement system (VES) and any traffic control lights, barriers and the like.

Once tag device 102 arrives within the designated distance from the toll plaza and communicates with tag reader 106, the usage data collection process is initiated. During this process, tag reader 106 reads the pre-loaded information for validation purposes, and acting with toll host 110, can begin logging the needed usage information. The usage information can then be transferred to processing and account management system 112 for post processing to adjust a toll account, wherein the toll amount is calculated and deducted from the prepaid toll account.

While the preloaded account method can provide an adequate speed and logging of transactions at the toll facility, the preloaded account method requires huge, expensive processing and account management systems 112 to post process the transactions. Further, in that the preloaded account method utilizes a post processing method to adjust account balances, i.e., after the vehicle has passed through the toll collection point, in many instances the account balance can be overdrawn. Moreover, very few security provisions are implemented in this method, thus allowing information to be transferred from tag device 102 to processing and account management system 112 that can be readily accessed by unauthorized users.

In the stored value method of payment, tag device 102 is configured with a highly specialized, intelligent transponder device that is capable of calculating tolls and managing stored value, so that the toll can be calculated and paid as the vehicle passes through the toll collection point. In this example, tag device 102 can be loaded by a variety of loading devices, such as a smart card or an online loading device. This method requires the loading of the user information and stored value in the smart, agency specific transponder device because toll collection system 103 cannot process the information fast enough from a smart card or other loading device. Moreover, because the loading of information requires a significant amount of time, the agency specific, smart transponder must be preloaded with the user information and stored value prior to entering toll collection system 103.

While the stored value methods eliminate much of the post processing in processing and account management system 112, such methods have difficulty in providing the level of security needed to transfer value and information in a payment transaction system, e.g., the data is not tamper resistant, and is not generally secured during transfer between tag device 102 and reader device 106

In addition to the above problems, the above methods have difficulty in being configured for more than one type of processing system, or accepting more than one type of smart card or loading device schemes, and instead are configured for only one particular agency's processing hardware and software.

Thus, while present electronic payment systems may be capable in tracking toll activities, such as vehicles passing through highway tolls, or passengers passing through bus and train turnstiles, and in some cases, collecting prepaid value from highly specialized tag devices 102, difficulty exists in accepting and processing stored value from a variety of smart card devices and for processing complex payment transactions resulting from continued use of these electronic payment systems. Accordingly, a need exists for a high speed, highly secure transaction management system capable of handling large volumes of complex transactions from a plurality of smart card devices and stored value schemes.

### SUMMARY OF THE INVENTION

The method and system for managing transactions overcomes many of the problems of the prior art. In accordance with various aspects of the present invention, a high speed, highly secure transaction management system and method capable of managing large volumes of complex transactions, that require a high level of security, can be provided. Such transaction sources may include, but are not limited to, the electronic toll and fare collection industry.

In accordance with an exemplary embodiment, transaction management system may comprise a transaction management module including a tamper resistant hardware containing, for example, memory and data storage components, and a processor device for controlling, processing and managing transactions and related data and information. In addition, in accordance with various exemplary embodiments, a transaction management system may be configured with one or more processing components.

In accordance with another aspect of the present invention, a transaction management system can be suitably configured for facilitating offline calculation of the toll amount, for example, a payment transaction that can be conducted locally rather than through the post processing of a prepaid account, and for providing secure payment transactions between the various devices and components. In accordance with an exemplary embodiment, a transaction management system is suitably configured for facilitating payment at the time of use, e.g., when the vehicle enters the toll collection point. In accordance with this embodiment, transaction management system can provide stored value contained on a smart card, and use a non-specialized transponder device to facilitate communications from the smart card device to a reader module and a transaction management module. Transaction management system can then be configured for debiting and crediting the stored value as transactions are incurred locally. The smart card component can be configured to authorize payment and collect transaction records in such a manner as to allow settlement of funds between various issuers, acquirers and operators of electronic toll collection systems. As a result, the process can significantly increase the speed of transactions, thus enabling the transactions to occur locally, such as when a transponder is proximate to a toll collection system.

In accordance with another aspect of the present invention, a transaction management system can be configured to address multiple types of stored value applications. For example, an exemplary transaction management system can be configured to operate from a plurality of transaction sources using a plurality of smart device types configured to use a plurality of stored value schemes, e.g., an exemplary transaction management system can address multiple types of smart cards, multiple types of security schemes, high volume transactions, multiple processing transactions, different types of transactions, and different types of collection systems.

### BRIEF DESCRIPTION OF THE DRAWINGS

A more complete understanding of the present invention may be derived by referring to the detailed description when considered in connection with the drawing figures, and:

FIG. 1 illustrates a block diagram of a prior art electronic toll collection system for processing payments and managing transactions;

FIG. 2 illustrates a block diagram of an exemplary embodiment of a transaction management system in accordance with the present invention;

FIG. 3 illustrates a block diagram of another exemplary embodiment of a transaction management system in accordance with the present invention;

FIG. 4 illustrates an exemplary embodiment of a method for managing and processing transactions in accordance with the present invention;

FIG. 5 illustrates an exemplary embodiment of a method for managing and processing transactions in accordance with the present invention;

FIG. 6 illustrates an exemplary embodiment of a transaction management module for managing and processing transactions in accordance with the present invention; and

FIG. 7 illustrates an exemplary embodiment of a transponder device in accordance with the present invention.

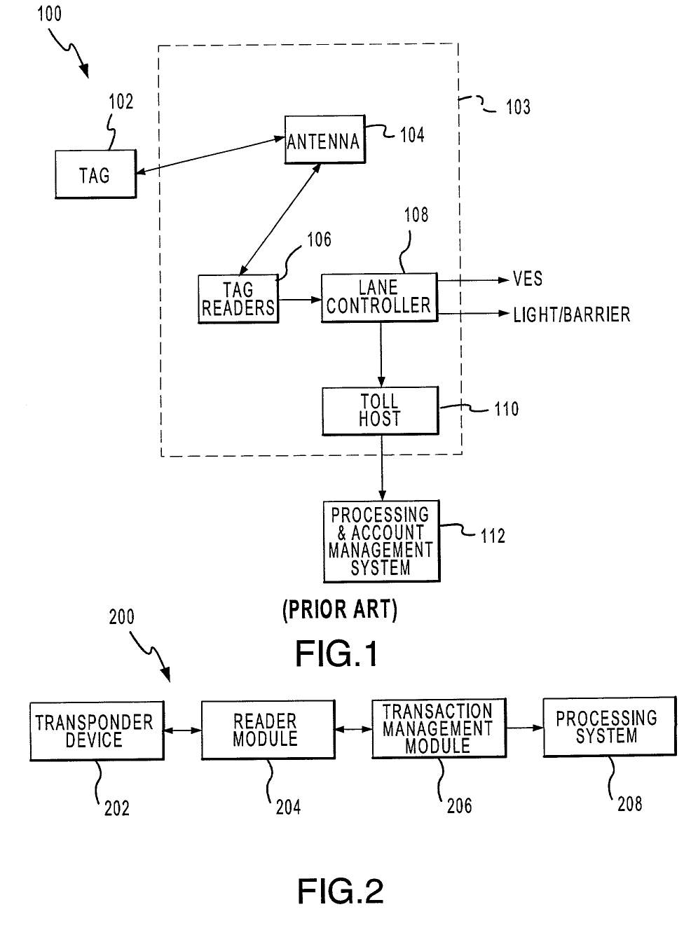

### DETAILED DESCRIPTION

The present invention may be described herein in terms of various software modules and processing steps. It should be appreciated that such modules and steps may be realized by any number of hardware components configured to perform the specified functions. For example, the present invention may employ various input/output devices, data storage and memory devices, terminals, security devices, and the like, which may carry out a variety of functions under the control of one or more microprocessors or other control devices. In addition, those skilled in the art will appreciate that the present invention may be practiced in any number of transaction processing contexts and that the illustrative embodiment as described herein is merely one exemplary application for the invention. For example, the present invention may be applicable to parking facilities, such as airports or commercial buildings. Further, such general techniques that may be known to those skilled in the art are not described in detail herein.

As discussed above, present electronic transaction systems have difficulty in securely processing high numbers of complex transactions at high speeds. For example, in present toll collection systems, the transaction processing must be restricted so that the transaction can be completed while the smart transponder devices are in contact with the toll collection systems, thus compromising the security of the transfer of value from one component to another. Moreover, multiple or different types of transactions provide a significant burden on present toll collection systems. However, in accordance with the present invention, a high speed, highly secure transaction management method and system capable of managing large volumes of complex transactions, including those that require a high level of security, is provided. In accordance with various aspects of the present invention, the transaction management method and system can be configured to securely process and manage a high volume of transactions from a plurality of transaction sources, e.g., different users and acquirers, different transaction types, and multiple processing of same.

In accordance with an exemplary embodiment, with reference to FIG. 2, an exemplary transaction management system 200 comprises a transponder device 202, a reader module 204, a transaction management module 206, and a processing system 208. Transponder device 202 suitably comprises a device configured for facilitating the identification of a system user desirous of conducting a transaction, e.g., paying a fare, toll or other expense. Transponder device 202 can comprise any device or system for temporarily storing and communicating information and data about the user, such as, for example, the identity of the user, address and billing information, credit card or other banking information, or any other account information. For example, for toll applications, transponder device 202 can include storage of information relating to vehicle size, class or other vehicle characteristics. Transponder device 202 can also be configured to communicate with reader module 204, such as by direct network or other wiring connection, such as a card scanning system in a bus terminal. In addition, as will be discussed in more detail below, transponder device 202 can be suitably configured for wireless communications with reader module 204, such as through one or more antennae or satellite systems.

Reader module 204 is suitably configured for communicating with transponder device 202 to read and assess the information and data corresponding to the user of transponder device 202. For example, the information and data can be received by reader module 204, and then processed or otherwise organized by reader module 204 to facilitate the transaction process. Reader module 204 can comprise any configuration for communicating with transponder device 202 and for providing the read and assessed information to transaction management module 206.

Transaction management module 206 suitably comprises a component, module or system for facilitating the management and processing of transactions, including facilitating the initiation, authentication and authorization functions in the transaction. Transaction management module 206 may be configured in various hardware and software arrangements and include various components, modules and devices. In accordance with an exemplary embodiment, transaction management module 206 may include tamper resistant hardware containing, for example, memory and data storage components, and a processor device for controlling, processing and managing transactions and related data and information.

To facilitate high speed communications and transactions, transaction management module 206 comprises a high speed processor device. In addition, in accordance with various exemplary embodiments, as will be described in more detail below, transaction management module 206 may be configured with one or more processing components, including, for example, a connection manager, a transaction context manager, a transaction normalization module, security module, amount calculation module, key management module, and transaction collection module.

Processing system 208 suitably comprises any conventional transaction processing and account management system. Processing system may be suitably configured for local communications with transaction management module 206, or for communications through network or other linking communication techniques. As a result, transaction management system 200 can suitably provide for the managing and processing of large volumes of complex transactions through a networked processing system 208 for completing the transaction processing functions.

In accordance with another aspect of the present invention, transaction management system 200 can be suitably configured for facilitating offline calculation of the toll amount, for example, a payment transaction that can be conducted locally rather than through the post processing of a prepaid account, and for providing secure payment transactions between the various devices and components. In accordance with an exemplary embodiment, transaction management system 200 can be suitably configured with a smart card component or module that is configured for facilitating payment of transactions by storing value on the smart card component or module, and for debiting the stored value as transactions are incurred. To communicate with transaction management system 200, the smart card component can be interfaced with transponder device 202. For example, with reference to FIG. 7, an exemplary transponder device 202 can comprise a smart card 702 and a transponder unit 704.

Smart card 702 can comprise any purse capable, integrated circuit card capable of providing a stored value representing preloaded value for the user, and configured to facilitate the secured and reliable payment of transactions directly from the card, e.g., an offline transaction for transferring said store value between smart card 702 and transaction management module 206. These stored value functions can include payment token features that enable a user to purchase payment tokens for future use, such as for highway tolls, bus and parking fares, or other like transactional activities. In addition, smart card 702 can either include, or supplement, any data or other information re the user, e.g., the vehicle type, class, size.

Transponder unit 704 is suitably configured to facilitate communications between smart card 702 and a reader module, such as reader module 204. In accordance with an exemplary embodiment, transponder unit 704 suitably comprises a smart card reader configured for interfacing to smart card 702, and for communicating the stored value information between smart card 702 and the reader module. Notably, since the stored value and debiting functions can be suitably conducted directly on smart card 702, transponder unit 704 does not need to be an intelligent or smart, highly specialized transponder device, but instead can be any conventional transponder device for providing a communication interface between smart card 702 and transaction management module 206.

Accordingly, by using a stored value payment token device such as smart card 704, payment for transactions can be accomplished locally at the point of the transaction, e.g., at the location where a vehicle passes through a toll lane. Since the source of value for the payment is resident on smart card 702, the funds verification can be conducted locally, offline to determine that sufficient value exists to pay the transaction. The calculated or pre-determined amount can then be deducted immediately with the new value balance that is recorded on smart card 702. As a result, the speed of the transaction process can be increased significantly.

Moreover, by using the transaction management module 206, neither smart card device 702 nor the transponder device 202 needs to have the ability to calculate the payment amount, or to determine that the transaction is a toll, fare, or fee payment type, but only that it is a stored value payment.

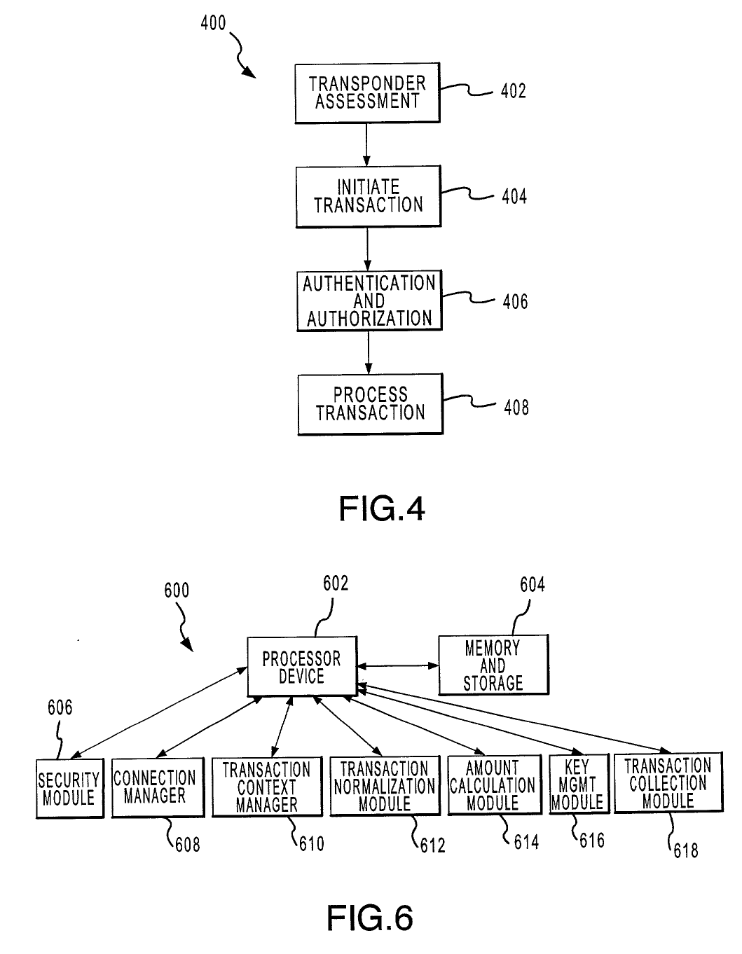

Having described an exemplary embodiment of transaction management system 200, an exemplary method of operation can be provided. With additional reference to FIG. 4, and continued reference to FIGS. 2 and 7, an exemplary method for managing transactions can comprise a transponder assessment step 402, an initiate transaction step 404, an authentication and authorization step 406 and a process transaction step 408.

In transponder assessment step 402, transponder device 202 can determine and assess whether the data and information contained within transponder device 202 is appropriate. For example, a balance statement can be provided for further review by the user. Other types of indicators to confirm the accuracy or amounts of data configured with transponder device 202 can be included. In accordance with an exemplary embodiment comprising smart card 702, transponder assessment step 402 can include the insertion or interfacing of smart card 702 into transponder unit 704 to permit transponder unit to assess the stored value and other information on smart card 702 for facilitating communications between smart card 702 and reader module 204.

Upon assessing the data and information, reader module 204 can begin communications with transponder device 202 in initiate transaction step 404, such as by transponder device 202 entering within a designated receiving area of reader module 204, e.g., within close enough proximity of receiving module 204 to receive transponder signals. In addition, transaction management module 206 can be suitably contacted by transponder device 202 through reader module 204 to suitably request a payment transaction to occur, such as a debit request to smart card 702.

In authentication and authorization step 408, transaction management module 206 can be configured to authenticate the contents of information communicated from transponder device 202, e.g., the data and information of smart card 702, to confirm the authentication, permission and/or accuracy of the information. In addition, transaction management module 206 can compute the amount of the transaction and respond with a debit authorization to processing system 208, or in the case of a smart card 702 implementation, to transponder 202 to authorize debiting of smart card 702.

Upon obtaining authorization, the transaction can be processed in process transaction step 408. For example, for a smart card 702 application, transponder device 202 can be configured to debit smart card 702 for the appropriate transaction amount, and then follow-up with processing system 208 to update the account.

As a result, the complete transaction can occur without the need to post process the transaction on a prepaid account, or without the need to preload a highly specialized, intelligent, agency specific transponder device. Further, the stored value can remain on the smart card device until payment is required by any collection systems.

Having described in general various features and exemplary embodiments of the present invention, a more detailed implementation of a method and system for managing transactions will be described in connection with an electronic toll collection system. However, it should again be noted that the following example is merely for illustration purposes, and that the various exemplary embodiments can be suitably implemented in any transactional application. For example, the exemplary method and systems could be suitably implemented in bus fare collections, parking garage or any other toll, fare or fee transaction process. In addition, while the exemplary embodiment can include the implementation of a smart card device for use in processing the account information, other exemplary embodiments can be provided for both online and offline processing.

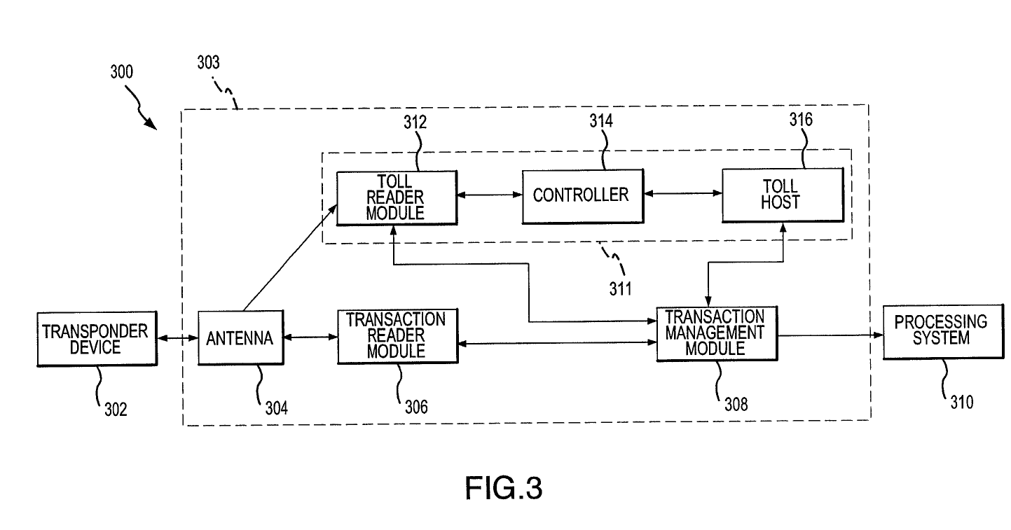

In accordance with an exemplary embodiment, a transactional management system 300 is illustrated in FIG. 3. Transactional management system 300 suitably comprises a transponder device 302 configured for providing user account information, such as through a smart card or other payment token system, a local toll transaction system 303 for authenticating and authorizing payment, and a processing system 310 for post processing and account and system settlement.

In accordance with this exemplary embodiment, transponder device 302 can comprise a smart card based transponder unit configured to interface with a smart card device, such as smart card 702, to facilitate the transfer of account information to and from toll transaction system 303. In addition, transponder device 302 can be configured to assess the contents of the smart card to facilitate the authentication, authorization and/or crediting and debiting functions of transactional management system 300. Further, transponder device 302 can also be configured for temporarily storing information and data regarding the system user for communications within toll transaction system 303. Notably, transponder device 302 can comprise any conventional transponder unit for facilitating communications between the smart card and the transaction management module, and does not need to be an intelligent, highly specialized transponder unit as required by prior art systems.

For conducting the processing and managing of toll transactions, toll transaction system 303 suitably comprises a transaction reader module 306 and a transaction management module 308. Transaction reader module 306 suitably comprises a device configured for communicating to transponder device 302 to suitably read and transmit any information regarding the smart card and transaction account. This communication process can be conducted in various manners, such as through direct coupling or connection to transponder device 302, or through wireless communications, such as radio, infrared or satellite signals, as may be received by one or more antennae systems 304.

Transaction management module 308 suitably comprises a module for facilitating the management and processing of transactions, including facilitating the authentication, authorization and debiting/crediting functions in the transaction process. Transaction management module 308 may be configured in various hardware and software arrangement and include various components, modules and devices. In accordance with an exemplary embodiment, transaction management module 308 may include tamper resistant hardware containing, for example, memory and data storage components, and a processor device for controlling, processing and managing transactions and related data and information.

For example, with reference to FIG. 6, an exemplary transaction management module 600 is illustrated. In accordance with this exemplary embodiment, transaction management module 600 suitably comprises a processor device 602 and a memory and storage device 604. Processor device 602 suitably comprises a high speed, microprocessor-based system that may be configured for controlling, processing and managing transactions and related data and information directly with a smart card device 702, such as through use of transponder device 302 and reader module 306. Memory and storage device 604 suitably comprises any conventional data memory and storage device or system configured for storing data and information related to transaction accounts.

In addition, in accordance with the exemplary embodiments, transaction management module 308 may be configured with one or more processing components, including, for example, a security manager 606 for facilitating secured transactions, a connection manager 608 for managing multiple connections, a transaction context manager 610 for maintaining the context of what devices are being utilized and the sequence of execution for complex transactions, a transaction normalization module 612 for normalizing the received data, an amount calculation module 614, a key management module 616 for managing multiple keys in a particular transaction, and transaction collection module 618 for facilitating batch transferring of collected payment transactions. However, in accordance with various other exemplary embodiments, fewer or additional modules and components can be included within transaction management module 308.

Processing system 310 suitably comprises any system configured for processing and settling transaction accounts for a plurality of users. In accordance with an exemplary embodiment, processing system 310 is configured to be coupled to transaction management module 308 through a network connection, e.g., transaction management module 308 communicates in an online manner with processing system 310. Still further, although a network connection is illustrated, processing system 310 can also be configured within toll transaction system 303.

In addition, in that transaction authorization and verification functions can be carried out directly between transaction management module 308 and the smart card device through transponder device 302, any processing of transactions can be performed by processing system 310 significantly after the payment and validation processes have occurred. In other words, the processing of transactions can occur for the purposes of updating the accounts of users, and not for the purposes of validation and authorization. Such processing of transactions can be conducted in many forms, for example, one at a time after each payment transaction occurs, or in a batch of transactions uploaded from transaction management module 308. Still further, processing system 310 can be configured to facilitate funds settlement at any given time during the process. In accordance with an exemplary embodiment, transaction collection module 618 is suitably configured for collection transactions and providing in batch transactions to a processing system.

In accordance with an exemplary embodiment, toll transaction system 303 can also be configured for communicating with an isolated toll collection system 311 to facilitate the permission for a vehicle to pass through a collection point. In accordance with this exemplary embodiment, toll collection system 311 suitably includes as toll reader module 312, a controller 314 and a toll host 316. Toll reader module 312 suitably comprises any conventional reader device or module that may be configured for reading information and data provided by a transponder device, such as transponder device 302. In accordance with an exemplary embodiment, toll reader module 312 is integrated into toll collection system 311. To facilitate communications, toll reader module 312 can also utilize one or more antennae systems 304, include the same or different antennae used by transaction reader module 306.

Controller 314 suitably comprises a device configured for controlling various output devices for toll collection system 311, such as lights, barriers, gates, turnstiles, or other devices for restricting access and/or for providing permission to a user to pass through the collection point. Meanwhile, toll host 316 suitably comprises any conventional host computer or processor configured for operating and controlling various functions of toll collection system 311, and for communicating to transaction management module 308 the activities occurring within toll collection system 311. For example, the confirmation of validations, permissions and completion of tasks can be communicated to transaction management module 308, while being isolated from the smart card information, and the authentication, authorization and processing functions.

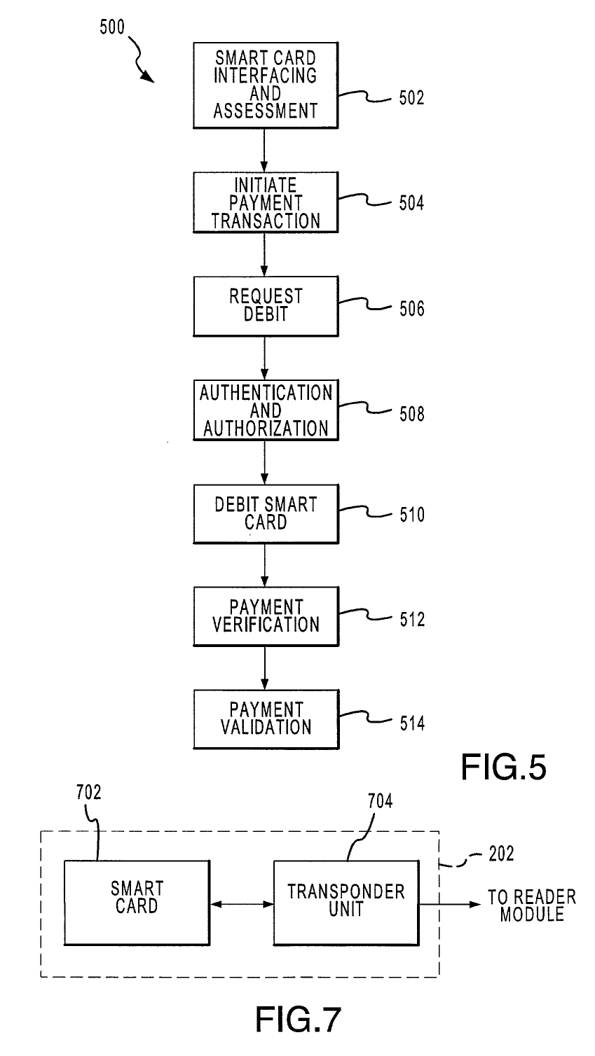

As a result, transaction management system 300 can facilitate settlement of funds between various issuers, acquirers and operators of electronic toll collection systems, while maintaining in isolation the transaction collection system 311 from the authentication, authorization, security and network processing applications. Having described a more detailed exemplary embodiment of a transaction management system 300 in connection with a toll collection implementation, an exemplary operation of transaction management system 300 can be provided. With reference to FIG. 5, an exemplary method for managing transactions, such as for transaction management system 300, is illustrated. In accordance with this exemplary method, a smart card implementation will again be provided for conducting high speed, secure transactions. However, other devices and mechanisms configured for facilitating high speed, secure transactions can be implemented as well.

In accordance with an exemplary embodiment, with continued reference to FIG. 3, a method for managing transactions 500 is suitably configured for facilitating direct transactions, i.e., transactions processed directly between a user smart card device and a transaction management system, rather than requiring use of a post processing of a prepaid account, or the preloading of an intelligent, highly specialized, transponder device. Initially, in a smart card interfacing and assessment step 502, a smart card or other payment token device can be interfaced with transponder device 302 to permit transponder device 302 to evaluate and assess the contents of the smart card, e.g., to assess account balances, user information, such as vehicle size, class, weight, and the like for facilitating communications between a smart card device and transaction management module 308.

Upon completing the assessment, the transaction process can be initiated in an initiate payment transaction step 504. In step 504, transponder device 302 can be suitably configured to establish a communication connection with transaction reader module 306, e.g., by having a vehicle enter within a designated receiving area or otherwise within close enough proximity of reader module 306 to enable the receiving of information from transponder device 302.

Once the transaction process is initiated, transponder device 302 can suitably provide one or more debit requests from the smart card device to transaction management module 308 in a request debit step 506.

Upon receiving the debit requests, the authentication of the transponder and the authorization of the transaction can be conducted in step 508. In this step, transaction management module 308 can be configured to authenticate the information communicated from transponder device 302, such as by conducting a process to authenticate the contents and user for the smart card. In accordance with another aspect of the present invention, this authentication process can be conducted through the implementation of various security features to prevent the unauthorized use of a smart card by others. These features can be configured within a security module, such as security module 606.

For example, in applications where the funds available for payment reside on a token in electronic form, such as in a smart card-based application, security safeguards can be provided to prevent fraudulent practices and activities, such as producing unauthorized payment tokens or tampering with the value amounts that are stored on legitimate smart cards. Accordingly, transaction management system 300 can suitably provide various functions for securing offline transactions. For example, by employing a technique that generates an authorization cryptogram for each transaction, transaction management system 300 can suitably identify a smart card configured with a transponder device 302 and associated payment token as valid to toll collection system 311. Each cryptogram can be configured to be unique per payment occurrence, and thus can only be produced or received with a valid smart card.

In addition to the security aspects during authentication, step 508 can also be configured to compute the amount of any toll, fare or other fee, such as through use of amount calculation module 614. Upon calculating the amount of payment, step 508 can be configured to conduct authorization for the payment transaction to verify that sufficient funds are available and to authorize the debiting of the payment amount to transponder device 302 for direct debiting of the smart card device. During authorization, additional security features can be implemented, such as the cryptographic techniques described above in connection with authentication processes, such that the authorization can be provided from transaction management module 308 to transponder device 302.

Upon receiving authorization from transaction management module 308, transponder device 302 is suitably configured to debit the smart card by the amount of payment authorized. Like the authentication and authorization functions above, the debit of value from the smart card can also be protected by a debit cryptogram that can be generated uniquely per payment transaction occurrence, thus certifying the payment to both the vehicle operator and, through an isolated connection provided by the transaction management module 308, to the toll collection system or authority. Upon completion of the debit process, transponder device 302 can also communicate or otherwise confirm to transaction management module 308 of such completion.

In addition to the debit confirmation, transaction management module 308 can also communicate to processing system 310 to permit the corresponding account to be adjusted to reflect the debit activity in step 510. For example, when the transaction is completed, the transaction can be suitably sent to processing system to settle the account, or the transaction can be suitably logged by transaction management module 308 for subsequent batching and transmittal for settlement to processing system 310. Moreover, pertinent cryptographic information can be maintained in every transaction record so that any transaction can be Ad verified in the settlement process.

In addition to the completion of the direct transaction processing activities, the exemplary method for managing transactions 500 can also be configured to include steps for facilitating verification and validation by toll collection system 311, and which can be suitably isolated by transaction management module 308 from the authentication, authorization, debiting and processing steps. For example, in a payment verification step 512, toll reader module 312 may be configured to acquire the output signal of transponder device 302, e.g., when transponder device 302 enters within close enough proximity of reader module 312 to enable the receiving of information from the smart card device via transponder device 302. Once the signal of transponder device 302 is obtained, toll reader module 312 can request payment verification from transaction management module 308. Accordingly, once the payment has been authorized by transaction management module 308, and been confirmed by transponder device 302, transaction management module 308 can suitably provide an indication of payment verification to toll reader module 312.

Once verification is received, toll reader module 312 can suitably validate transponder device 302 as being a paid transaction in payment validation step 514. As a result, toll reader module 312 can then suitably communicate to controller 314 that payment has been validated, thus permitting controller 314 to suitably operate any corresponding light, barrier, gate or other devices or systems for permitting vehicles or passengers to pass through the collection point.

Accordingly, the exemplary method for managing transactions 500 can provide a faster, more efficient transaction process between a user and a toll collection system, for example, by providing authorization and validation functions directly with the smart card device while the user transponder device is in communication with toll collection system, rather than requiring the online validation through a post processing of a prepaid account, or through a highly specialized, intelligent transponder device. In addition, the toll collection systems can be suitably isolated from the authentication, authorization, debiting and processing processes of the transaction management system, rather than in an unsecured manner between a smart, agency specific transponder unit with the toll collection system.

While the above method describes various processing steps, it should be noted that various of the steps may be suitably modified and/or the order of those processing steps may be re-arranged, and the above method is for illustrative purposes only. For example, validation step 512 could occur simultaneously or prior to debit step 510 in accordance with other exemplary embodiments.

As discussed above with respect to the authentication and verification functions, the various exemplary methods and systems for managing transactions can be suitably configured with various security features in terms of functionality, component integration and system communication. However, other security features can be included within the various exemplary methods and systems for managing transactions, and can be suitably included within security module 606.

For example, another security feature within security module 606 of transaction management module 600 can include an interface that operates as a secure mechanism for storage of cryptographic keys, including, for example, software modules that perform cryptographic functions. The interface is suitably configured to be flexible to allow interfacing to an external secure device, such as a smart card, or to an internally installed component, such as a crypto board. In accordance with an exemplary embodiment, key management module 616 is suitably configured for loading the keys specific for any module. For example, based on the need to select the correct encryption key for a particular transaction, key management module 616 provides the ability to download and update the encryption keys corresponding to a particular agency or smart card device.

Transaction management system 300 can also be capable of accepting cryptographic keys from a specialized smart card, e.g., a key card, or from any other secure storage device. Access to all software for performing the various functions can be restricted by limited physical access and by password control over any operator access. For example, in accordance with one exemplary embodiment, transaction management system 300 can be configured without a standard keyboard/mouse or screen monitor support. In accordance with this embodiment, physical access is achieved only through a designated port, using a portable computing device that is programmed to communicate with transaction management system 300. Moreover, the security features can be suitably isolated from any toll collection systems by the transaction management system.

In accordance with another aspect of the present invention, transaction management system 300 can be configured to address multiple types of applications. For example, transaction management system 300 can address high volume transactions, multiple processing transactions, different types of transactions, and different types of collection systems.

In accordance with this aspect of the present invention, transaction management system 300 can be configured with a hardware platform that can be suitably configured to be scalable in all respects in order to meet transaction volume requirements. Such hardware scalability allows the communications, processing, and storage capabilities of transaction management system 300 to be rapidly increased by incremental amounts that can be closely matched to existing or expected volume demands.

To facilitate the communications to multiple devices and systems, connection manager 608 can be suitably configured to facilitate the isolated connections between various devices and components to facilitate communications. For example, by employing modular software component technology within connection manager 608, transaction management system 300 can be configured to communicate with other isolated transaction systems of various types, including connections at both the link and network levels, as well as at the message protocol level. Transaction management system 300 can also be configured through connection manager 608 to connect to other systems via Internet technology, or incorporated into systems that are networked in a proprietary manner. Further, local area network and remote dial in capabilities can also be suitably included. Still further, different message protocols can be supported by plugging in or otherwise connection corresponding modules that can understand the message content. For example, transaction management system 300 can communicate with a toll plaza host system without requiring the host to adopt a different message protocol.

In addition, transaction management system 300 can be configured to be capable of simultaneous, multiple processing sessions. As a result, outside collection or processing systems that communicate with the transaction management system 300 do not have to wait while transaction management system 300 services another debit request. The software can suitably comprise object-based technology resulting in highly specialized components that maximize efficiency. These components can also communicate via message passing, allowing processing overlap, which can eliminate the blocking that can occur with sequential, in-line processing.

In accordance with an exemplary embodiment, transaction context manager 610 is suitably configured for facilitating the processing of multiple connections at one time. For example, during operation, transaction management module may be suitably communicating with several transponder devices, reader modules and other components from various vehicles and toll collection points. As a result, transaction management module needs to be able to ascertain which devices are being utilized. Accordingly, transaction context manager 610 maintains the context as to which transponder or reader devices is being utilized.

Further, transaction management system 300 can be programmed and configured to process transactions of different types and formats, simultaneously if required. For example, transaction management system 300 suitably normalizes different incoming transactions by recognizing pertinent information such as transaction amount, payment acquirer, and the like. This information can be reformatted into a standard transaction template, which serves as a consistent output format that can be recognized by any system with which transaction management system 300 communicates.

In accordance with an exemplary embodiment, transaction normalization module 612 is suitably configured to normalize all payment transactions into a common format for processing. For example, while various types of smart cards may be issued from various agencies, and various toll collection systems may be utilized, transaction normalization module 612 provides an interface module for normalizing the payment transactions regardless of the type of device or agency equipment.

In addition to the above features, it may be desirable to have a payment token issued for one payment collection system to be valid within another operator's collection system. Thus, in accordance with another aspect of the present invention, transactions can be generated at one location by payment tokens that are issued by multiple entities. Furthermore, there are situations where payments collected at one location must be distributed to multiple payment acquirers. Accordingly, the transaction management system 300 can be configured with the capability to process such transactions and to distinguish between multiple issuers and multiple acquirers.

The present invention has been described above with reference to an exemplary embodiment. However, those skilled in the art will recognize that changes and modifications may be made to the exemplary embodiment without departing from the scope of the present invention. For example, the various processing steps dictated by the software, as well as the components for carrying out the processing steps, may be implemented in alternate ways depending upon the particular application or in consideration of any number of cost functions associated with the operation of the system. In addition, the transaction management system is not limited to any particular means for connection to a collection or payment tracking device, such as an electronic collection systems, and may utilize any other communication or connection means now known or hereinafter devised. Moreover, while smart card based applications may be preferable, any monetary storing device can be utilized in practicing the present invention. These and other changes or modifications are intended to be included within the scope of the present invention, as set forth in the following claims.

We claim:

1. A transaction management system for facilitating the managing and processing of transactions between multiple users and collection systems, said transaction management system comprising:
a transponder device configured for receiving and transmitting user information;
a reader module configured for communicating with said transponder device to facilitate assessment of said user information;
a transaction management module coupled to said reader module and being configured to authenticate said user information, and to authorize and secure payment transactions, wherein said transaction management module can expedite transaction processing by providing authorization of payment transactions while said transponder device is in communication with a toll collection system; and
a processing system configured for processing collected user transactions for the reconcilement and settlement of a user account based on secured processing by said transaction management module.

2. A transaction management system according to claim 1, wherein said transponder device further comprises:
a smart card device configured for storing user information including stored value acquired by the user;
a transponder unit configured for assessing user information stored on said smart card device, and for facilitating communications between said transponder device and said reader module; and
wherein said transaction management module is configured to facilitate the debiting of payment transactions directly to said smart card device through said transponder device, without the use of an online processing system.

3. A transaction management system according to claim 2, wherein said transaction management module further comprises:
a high speed processor device for controlling, processing and managing payment transactions;
a memory storage device configured for storing user information; and
a security module configured for facilitating secure transactions between the user and the collection system.

4. A transaction management system according to claim 3, wherein said security module is configured to generate a cryptogram for the payment transaction for use during authentication and authorization by said transaction management module.

5. A transaction management system according to claim 4, wherein said security module is further configured with a flexible interface for communicating with an external secure device comprising at least one of the smart card device and a crypto board, and configured for limiting access.

6. A transaction management system according to claim 2, wherein said transaction management module suitably comprises a connection manager for isolating a collection system from authentication, authorization and debiting operations performed between said transaction management module and said transponder device.

7. A transaction management system according to claim 2, wherein said transaction management module suitably comprises a transaction collection module for facilitating batch processing of transactions in said processing system.

8. A transaction management system according to claim 2, wherein said transaction management module suitably comprises a transaction context manager configured for maintaining context of a plurality of transaction collection devices.

9. A transaction management system according to claim 2, wherein said transaction management module suitably comprises a transaction normalization module configured for normalizing user information received.

10. A transaction management system according to claim 2, wherein said transaction management module suitably comprises a key management module for managing a plurality of keys for a plurality of transactions.

11. A transaction management system according to claim 2, wherein said transaction management system can be configured to communicate to an isolated collection system, said collection system comprising:
a reader module configured for receiving user information and for communicating to said transaction management module;
a controller device configured for controlling devices for restricting access by a user to another location; and
a toll host configured for communicating to said transaction management module and for providing verification and validation of payment transactions by the user, and wherein said collection system is isolated by said transaction management system from authentication, authorization and debiting operations performed between said transaction management module and said transponder device.

12. A method for facilitating the management of transactions between users and collection systems, said method comprising the steps of:
interfacing a smart card device containing user information to a transponder device to assess the user information;
initiating a payment transaction by establishing a communication connection between said transponder device and a reader module to enable transmission of the user information to a transaction management module;
providing a debit request from said transponder device to said transaction management module;
authorizing payment of the payment transaction by authenticating the user information contained on said transponder device, computing a payment amount based on the user information, and verifying sufficient funds exists on said smart card device; and
debiting said smart card device by the payment amount after said transponder device receives authorization instructions from said transaction management module.

13. A method according to claim 12, wherein said method further comprises the step of:
processing the payment transaction in a processing system to reflect debiting activity of said smart card device, said processing step occurring after said transaction management module has validated the payment transaction.

14. A method according to claim 12, wherein said method further comprises the steps of:
verifying the payment transaction by receiving the user information from said transponder device in a toll reader module, said toll reader module requesting verification from said transaction management module, and providing a verification of payment from said transaction management module; and
validating to a controller that the payment transaction has been verified such that said controller can permit access to a user for another location; and
wherein said payment transaction is completed while said transponder device is in communication with said toll reader module.

15. A method according to claim 14, wherein said validating step is performed prior to processing the payment transaction in said processing system.

16. A method according to claim 13, wherein said processing step can be performed in batch processing of payment transactions.

17. A method according to claim 12, wherein said step of authorizing payment comprises generating a cryptogram for the payment transaction for use during authentication and authorization by said transaction management module.

18. A method according to claim 12, wherein said method can be configured with multiple collection systems without requiring multiple communication protocols.

19. A method according to claim 12, wherein said method can be configured to process simultaneous, multiple transactions by providing multiple debit authorizations to multiple smart card devices without requiring validation from an online processing system.

20. A method according to claim 12, wherein said method can be configured for normalization any payment transactions into a common format for processing.
